(19) United States
(12) Patent Application Publication
(10) Pub. No.: US 2013/0107587 A1
(43) Pub. Date: May 2, 2013

(54) PHOTOVOLTAIC ARRAY EMULATORS

(71) Applicants: Chunchun Xu, Boones Mill, VA (US); David Smith, Daleville, VA (US); Luis Jose Garcés, Niskayuna, NY (US)

(72) Inventors: Chunchun Xu, Boones Mill, VA (US); David Smith, Daleville, VA (US); Luis Jose Garcés, Niskayuna, NY (US)

(21) Appl. No.: 13/286,555

(22) Filed: Nov. 1, 2011

(51) Int. Cl. H02M 5/458; H02M 7/48; H02M 7/217

(52) U.S. Cl. 363/37; 363/127; 363/71

(57) ABSTRACT

Photovoltaic (PV) array emulators and methods are described. In one example, a method for use in testing a PV inverter includes coupling a first PV inverter to an alternating current (AC) power source. A second PV inverter is coupled to receive an output of the first PV inverter. The first PV inverter is operated to emulate a PV array and provide a DC power output to the second PV inverter.

### BACKGROUND OF THE INVENTION

This invention relates generally to methods and apparatus for photovoltaic (PV) emulators and more particularly to PV array emulators for use in testing PV inverters.

Solar energy has increasingly become an attractive source of energy and has been recognized as a clean, renewable alternative form of energy. PV cells, or modules, generate direct current (DC) power with the level of DC current being dependent on solar irradiation and the level of DC voltage being dependent on temperature. In order to obtain a higher current and voltage, multiple PV cells are often electrically connected to form a PV array. When alternating current (AC) power is desired, an inverter is used to convert the DC power output by the PV cell or array into AC power. Typically, PV inverters employ a single stage or two stages for power processing. For two stages, the first stage is configured for providing a constant DC voltage and the second stage is configured for converting the constant DC voltage to an AC current and voltage that is compatible with an electric grid.

Various approaches have been used to test operation of PV inverters. Some early PV inverters were tested by connecting the PV inverter to an actual PV array. More recently, PV array emulators have been developed to emulate a PV array to permit testing of a PV inverter. At least some known PV array emulators use a highly simplified linear model of the I-V curve for a PV array. Some other known PV array emulators are only capable of emulating relatively low power PV arrays.

### BRIEF DESCRIPTION OF THE INVENTION

In one aspect, a photovoltaic (PV) array emulator includes a multi-stage power converter for providing a DC output, and a controller coupled to the multi-stage power converter. The controller is configured to control operation of the multi-stage power converter as a function of an output current of the multi-stage power converter, an output voltage of the multi-stage power converter, and a PV array model.

In another aspect, a photovoltaic (PV) array emulator includes a PV inverter configured to provide an AC output from a DC input, and a controller coupled to the PV inverter. The controller is configured to operate the PV inverter in an inverter mode to provide an AC output from a DC input and configured to operate the PV inverter in an emulator mode to provide a DC output from an AC input.

In yet another aspect, an exemplary method for use in testing a photovoltaic (PV) inverter includes coupling a first PV inverter to an AC power source. A second PV inverter is coupled to receive an output of the first PV inverter. The first PV inverter is operated to emulate a PV array and provide a DC power output to the second PV inverter.

### BRIEF DESCRIPTION OF THE DRAWINGS

FIG. 1 is a block diagram of an exemplary photovoltaic (PV) emulator.

FIG. 2 is a functional block diagram of a control system for use with the PV emulator shown in FIG. 1.

FIG. 3 is a schematic diagram of the PV emulator shown in FIG. 1 coupled to an exemplary PV inverter.

FIG. 4 is a block diagram of an exemplary method for use in testing a PV inverter.

### DETAILED DESCRIPTION OF THE INVENTION

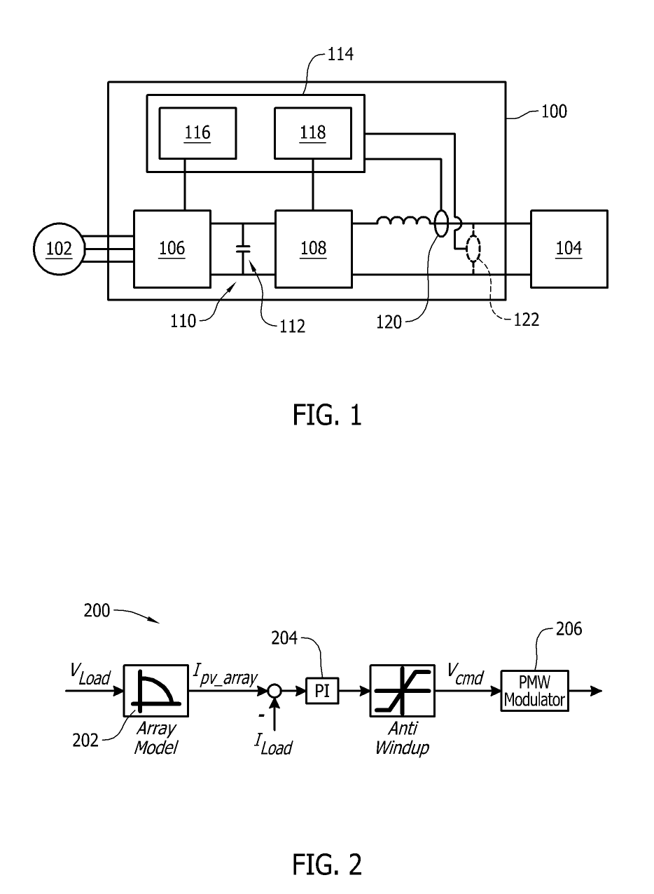

FIG. 1 is a simplified diagram of an exemplary photovoltaic (PV) emulator 100. Emulator 100 receives alternating current (AC) power from AC power source 102 and output direct current (DC) power to a PV inverter 104.

In the exemplary embodiment, PV emulator 100 is a multi-stage converter. More particularly, emulator 100 includes an AC to DC converter as a first stage converter 106 and a DC to DC converter as a second stage converter 108. In other embodiments, emulator 100 may include more than two stages. First stage converter 106 and second stage converter 108 are coupled together by a DC link 110 including a capacitor 112. First stage converter 106, in the exemplary embodiment, is coupled to, and receives AC power from, power source 102. In the exemplary embodiment, AC power source 102 is a three-phase power source. In other embodiments, AC power source 102 may include any other suitable number of phases of AC power including, for example, a single phase. First stage converter 106 converts the AC power received from AC power source 102 into DC power that is output to DC link 110. Second stage converter 108 is coupled to, and receives DC power from, first stage converter 106 via DC link 110. Moreover, second stage converter 108 adjusts the voltage and/or current amplitude of the DC power received. In the exemplary embodiment, second stage converter 108 operates as a buck converter to reduce the voltage on DC link 110 to a desired output voltage and current.

PV emulator 100 includes a control system 114 that includes a first stage controller 116, and a second stage controller 118. First stage controller 116 is coupled to, and controls an operation of, first stage 106. More specifically, in the exemplary embodiment, first stage controller 116 operates first stage 106 to convert the AC power received from AC power source 102 to DC power. Second stage controller 118 is coupled to, and controls the operation of, second stage 108. Specifically, in the exemplary embodiment, second stage controller 118 operates second stage 108 to convert the DC power received via DC link 110 to a desired DC power output. More specifically, second stage controller 118 operates second stage 108 to emulate the DC power output of a PV array. Even more specifically, second stage controller 118 operates second stage 108 to generate a DC output voltage, current, and power approximating the DC output voltage, current and power of a PV array subjected to the same output load as emulator 100.

In the exemplary embodiment control system 114, first stage controller 116, and/or second stage controller 118 include and/or are implemented by at least one processor. As used herein, the processor includes any suitable programmable circuit such as, without limitation, one or more systems and microcontrollers, microprocessors, reduced instruction set circuits (RISC), application specific integrated circuits (ASIC), programmable logic circuits (PLC), field programmable gate arrays (FPGA), and/or any other circuit capable of executing the functions described herein. The above examples are exemplary only, and thus are not intended to limit in any way the definition and/or meaning of the term “processor.” In addition, control system 114, first stage controller 116, and/or second stage controller 118 include at least one memory device (not shown) that stores computer-executable instructions and data, such as operating data, parameters, set points, threshold values, PV array models, equations, and/or any other data that enables control system 114 to function as described herein.

Control system 114, in the exemplary embodiment, receives output current measurements from current sensor 120. Moreover, control system 114 receives measurements of output voltage from voltage sensor 122. Based, at least in part, on the monitored output current and voltage, second stage controller 118 operates second stage converter 108 to emulate a PV array, as will be described in more detail below.

Control system 114 includes parameters for one or more specific PV modules. The stored parameters for each particular PV module include, for example, short circuit current (I_{SC}), open circuit voltage (V_{OC}), current at the maximum power point (I_{MP}), voltage at the maximum power point (V_{MP}), and/or fill factor. Moreover, some embodiments include one or more parameters based on the type of PV module, e.g., a thin film PV module, a crystalline silicon module, etc. PV type parameters may include, for example, a module temperature coefficient (β) in percent per degree Celsius. In some embodiments, control system 114 includes parameters for arrays of more than one PV module. Parameters for an array of more than one PV module may be determined by control system 114 by scaling proportionally from the parameters of a single PV module. In some embodiments, control system 114 determines parameters for an array of more than one PV module input by a user by scaling proportionally from the parameters of a single PV module.

Control system 114 includes operating conditions for which emulator 100 is to emulate one or more specific PV modules. The operating parameters include, for example, the nominal irradiance (Irr_{NORM}), and/or nominal temperature (T_{NORM}). In the exemplary embodiment, control system 114 includes default values for the operating conditions. The default operating conditions in the exemplary embodiment include a nominal irradiance of about 1000 watts per square meter, and a nominal temperature of about fifty degrees Celsius. Additionally, a user may select or input fixed and/or variable operating conditions to be simulated.

The PV module parameters and operating conditions are utilized by control system 114, and particularly by second stage controller 118, as part of a PV array model for emulating the behavior of the particular PV array to be modeled. More particularly, the PV module parameters and operating conditions are utilized in a simplified PV current-voltage (I-V) curve model. For the nominal operating conditions, the output current of a PV module is modeled as:

$$I = {I}_{SC} \times [ 1 - {C}_{1} ( {e}^{\frac{V}{{C}_{2} \times {V}_{OC}}} - 1 ) ] , \qquad ( 1 )$$

where “I” is the output current of a PV module and “V” is the output voltage of the PV module. Moreover, C1 and C2 are defined as:

$$\begin{matrix}{C}_{1} = ( 1 - \frac{{I}_{MP}}{{I}_{SC}} ) \times {e}^{\frac{- {V}_{MP}}{{C}_{2} \times {V}_{OC}}} & ( 2 ) \\ {C}_{2} = \frac{\frac{{V}_{MP}}{{V}_{OC}} - 1}{ln ( 1 - \frac{{I}_{MP}}{{I}_{SC}} )} & ( 3 )\end{matrix}$$

When conditions other than the nominal condition are to be simulated, the I-V curve can be scaled based on the changes of irradiance and temperature from the nominal conditions. For a particular output voltage, the nominal output power (P_{NORM}) of the PV module may be determined by multiplying the result of equation (1) by the output voltage of the PV module. The non-nominal power output (P) of the PV module is scaled from the nominal power output (P_{NORM}) using:

$$P = {P}_{NORM} \times \frac{Irr}{{Irr}_{NORM}} \times ( 1 + \frac{β}{100} \times ( T - {T}_{NORM} ) ) , \qquad ( 4 )$$

where “Irr” is the non-nominal irradiance in watts per square meter, “T” is the non-nominal temperature in degrees Celsius, and “β” is the PV module type temperature coefficient. The non-nominal output voltage (V) of the PV module is scaled from the nominal output voltage (V_{NORM}) by:

$$V = {V}_{NORM} \times \frac{ln ( Irr )}{ln ( {Irr}_{NORM} )} \times ( 1 + \frac{β}{100} \times ( T - {T}_{NORM} ) ) \qquad ( 5 )$$

The non-nominal output current (I) for the PV module may then be determined using:

P=V×I (6)

In the exemplary embodiment, control system 114 utilizes equations (1)-(6), as applicable, to calculate a desired output current for emulator 102 based on the output voltage sensed via voltage sensor 122. The desired output current is the output current that a solar array being emulated would output under the load experienced by emulator 100. In other embodiments, control system 114 may determine a desired output current for emulator 102 at a particular output voltage via a look-up table containing values for output current derived from equation (1). Moreover, in some embodiments, combinations of calculating desired output current and retrieving desired output from a look-up table are utilized. For example, output current under nominal conditions may be determined via a look-up table and then scaled by control system 114 according to equations (4)-(6) for the particular operating conditions being emulated.

FIG. 2 is a simplified exemplary control diagram 200 of emulator 100. The output (or load) voltage of emulator 100 sensed by voltage sensor 122 is input to array model 202. Array model 202 determines the desired output current (Iₚᵥ_{_{—}}_{array}) of emulator 100 to simulate the PV module or array being emulated. The calculated desired output current operates as a reference signal to be compared to a current feedback signal. Specifically, an error signal is generated from the difference between the desired output current and the load current (I_{Load}) sensed by current sensor 120. The error signal is input to a proportional-integral (PI) controller 204 that outputs, subject to anti-windup measures, a voltage command signal (V_{cmd}). The voltage command signal is utilized by second stage controller 118 to control second stage converter 108. More specifically, the voltage command signal is used by a pulse width modulation (PWM) modulator 206 to control switches (not shown in FIGS. 1 and 2) in second stage converter 108 to drive the output current of emulator 100 toward the desired output current.

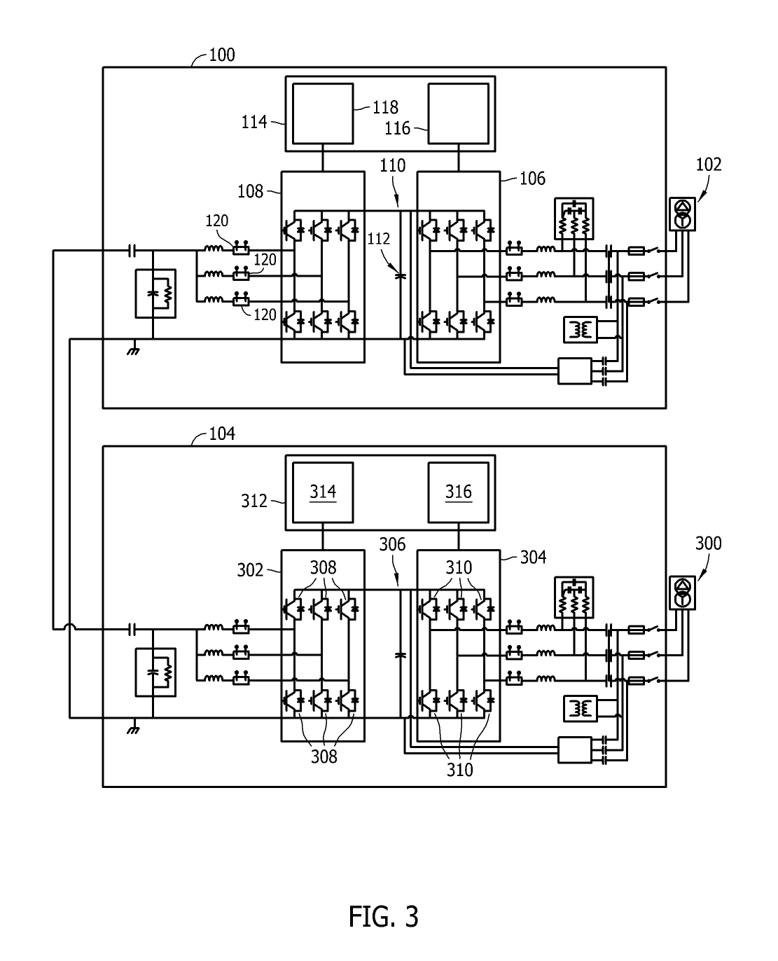

FIG. 3 is a schematic diagram of emulator 100 coupled to PV inverter 104. The structure and topology of emulator 100 is substantially identical to PV inverter 104. Moreover, in the exemplary embodiment, emulator 100 is identical to PV inverter 104, subject to tolerances, manufacturing variances, etc. In other embodiments, PV inverter 104 is not identical to emulator 100.

PV inverter 104 is operable to convert DC power to AC power. More specifically, in the exemplary embodiment, PV inverter 104 is configured to convert DC power received from emulator 100, which simulates a PV array, to AC power provided to an electrical distribution network (or grid) 300. In some embodiments, electrical distribution network 300 and AC power source 102 are the same.

In the exemplary embodiment, PV inverter 104 is a two-stage power converter. PV inverter 104 includes a DC to DC, or “boost,” converter 302 as a first stage and an inverter, or DC to AC converter, 304 as a second stage. Boost converter 302 and inverter 304 are coupled together by a DC bus 306 (also referred to sometimes as a DC link). Boost converter 302 adjusts the voltage and/or current amplitude of the DC power received from emulator 100. In the exemplary embodiment, inverter 304 is a DC-AC inverter that converts DC power received from boost converter 302, via DC bus 306, into AC power for transmission to electrical distribution network 300.

Boost converter 302, in the exemplary embodiment, includes two converter switches 308 coupled together in serial arrangement for each phase of electrical power that PV inverter 104 produces. In the exemplary embodiment, converter switches 308 are insulated gate bipolar transistors (IGBTs). Alternatively, converter switches 308 are any other suitable transistor or any other suitable switching device. Moreover, each pair of converter switches 308 for each phase is coupled in parallel with each pair of converter switches 308 for each other phase. Alternatively, boost converter 302 may include any suitable number of converter switches 308 arranged in any suitable configuration.

Inverter 304, in the exemplary embodiment, includes two inverter switches 310 coupled together in serial arrangement for each phase of electrical power that PV inverter 104 produces. In the exemplary embodiment, inverter switches 310 are insulated gate bipolar transistors (IGBTs). Alternatively, inverter switches 310 are any other suitable transistor or any other suitable switching device. Moreover, each pair of inverter switches 310 for each phase is coupled in parallel with each pair of inverter switches 310 for each other phase. Alternatively, inverter 304 may include any suitable number of inverter switches 310 arranged in any suitable configuration.

PV inverter 104 includes a control system 312 that includes a converter controller 314, and an inverter controller 316. Converter controller 314 is coupled to, and controls an operation of, boost converter 302. More specifically, in the exemplary embodiment, converter controller 314 operates boost converter 302 to maximize the power received from a solar array emulated by emulator 100. Inverter controller 316 is coupled to, and controls the operation of, inverter 304. More specifically, in the exemplary embodiment, inverter controller 316 operates inverter 304 to regulate the voltage across DC bus 306 and/or to adjust the voltage, current, power, and/or any other characteristic of the power output from inverter 304 to substantially match the characteristics of electrical distribution network 300.

In the exemplary embodiment control system 312, converter controller 314, and/or inverter controller 316 include and/or are implemented by at least one processor. As used herein, the term processor includes any suitable programmable circuit such as, without limitation, one or more systems and microcontrollers, microprocessors, reduced instruction set circuits (RISC), application specific integrated circuits (ASIC), programmable logic circuits (PLC), field programmable gate arrays (FPGA), and/or any other circuit capable of executing the functions described herein. The above examples are exemplary only, and thus are not intended to limit in any way the definition and/or meaning of the term “processor.” In addition, control system 312, converter controller 314, and/or inverter controller 316 include at least one memory device (not shown) that stores computer-executable instructions and data, such as operating data, parameters, set points, threshold values, and/or any other data that enables control system 312 to function as described herein.

During operation, in the exemplary embodiment, converter controller 314 controls a switching of converter switches 308 to adjust an output of boost converter 302. More specifically, in the exemplary embodiment, converter controller 314 controls the switching of converter switches 308 to adjust the voltage and/or current received from emulator 100 such that the power received from emulator 100, which is simulating a solar array, is increased and/or maximized.

Inverter controller 316, in the exemplary embodiment, controls a switching of inverter switches 310 to adjust an output of inverter 304. More specifically, in the exemplary embodiment, inverter controller 316 uses a suitable control algorithm, such as pulse width modulation (PWM) and/or any other control algorithm, to transform the DC power received from boost converter 302 into three phase AC power signals. Alternatively, inverter controller 316 causes inverter 304 to transform the DC power into a single phase AC power signal or any other signal that enables PV inverter 104 to function as described herein.

In the exemplary embodiment, emulator 100 is capable of outputting one megawatt of power. Moreover, emulator 100 is operable to produce a DC output of up to 1000 volts and up to 3000 amps. Further, in the exemplary embodiment, PV inverter 104 is a one megawatt inverter capable of outputting one megawatt of power. In another embodiment, emulator 100 is a 700 kilowatt emulator. In other embodiments, emulator 100 and/or PV inverter 104 are capable of handling greater and/or lesser amounts of power, voltage, and/or current. Moreover, in some embodiments, more than one emulator 100 are coupled together to increase the DC power output provided to PV inverter 104.

As described above, emulator 100 is substantially identical to PV inverter 104. Furthermore, emulator 100 is selectably configurable to operate in an emulator mode or an inverter mode. Selection of the mode in which to operate is made, in the exemplary embodiment, via a dip switch (not shown) selection. In other embodiments, the mode selection may be made by any other suitable method including, for example, via a graphical user interface, and/or via other switch selections. Similarly, PV inverter 104 is selectably configurable to operate in an inverter mode or an emulator mode. Hence, PV inverter 104 is selectably convertible to emulator 100, and emulator 100 is selectably convertible to PV inverter 104.

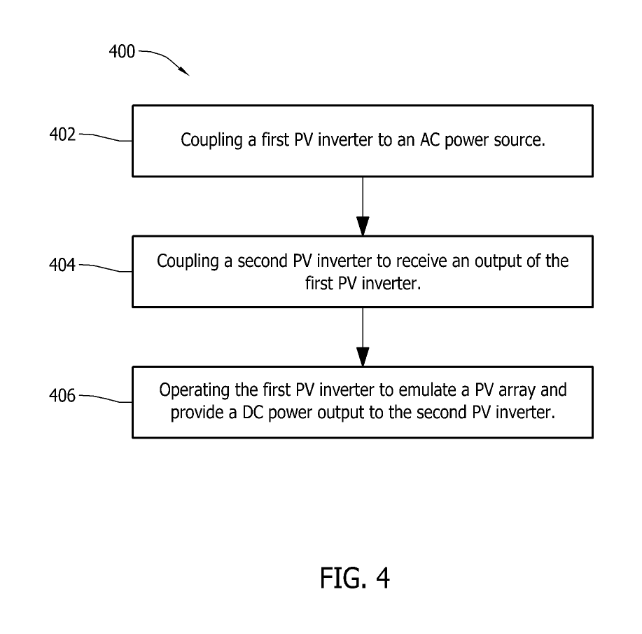

FIG. 4 is a block diagram of a method 400 for use in testing a PV inverter, such as PV inverter 104. A first PV inverter, such as emulator 100, is coupled 402 to an AC power source and a second PV inverter, such as PV inverter 104, is coupled 404 to receive an output of the first PV inverter. The first PV inverter is operated 406 to emulate a PV array and provide a DC power output to the second PV inverter.

Thus, PV emulators and methods described herein provide emulators capable of up to about 1 megawatt output. Further, the exemplary PV emulators may be scaled up or down to provide more or less power. Moreover, exemplary PV emulators are operable to emulate one or more PV modules coupled in an array based on characteristics of actual PV modules. The exemplary PV emulators proved an IV characteristic curve accurately tracking the IV curve of one or more PV modules. Moreover, the exemplary PV emulators are capable of simulating a PV array under various operating conditions including, for example, varying temperatures and different irradiance levels. The exemplary PV emulators may be used to test PV inverters. For example, the exemplary PV emulators may be used to test static and dynamic maximum power point tracking of a PV inverter, efficiency of a PV inverter, and/or grid validation features of an inverter. Furthermore, at least some exemplary PV emulators described herein are substantially identical to a PV inverter and can be selectably operated as a PV inverter or a PV emulator. Accordingly, one PV inverter may be utilized to test another PV inverter by selecting to operate one of the PV inverters as a PV emulator, which may result in a more efficient, cheaper, and/or quicker testing procedure.

Technical effects of the present invention include at least (a) coupling a first PV inverter to an AC power source; (b) coupling a second PV inverter to receive an output of the first PV inverter; and/or (c) operating the first PV inverter to emulate a PV array and provide a DC power output to the second PV inverter.

Some embodiments described herein involve the use of one or more computers or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

When introducing elements/components/etc. of the methods, systems, and apparatus described and/or illustrated herein, the articles “a”, “an”, “the”, and “said” are intended to mean that there are one or more of the element(s)/component(s)/etc. The terms “comprising”, “including”, and “having” are intended to be inclusive and mean that there may be additional element(s)/component(s)/etc. other than the listed element(s)/component(s)/etc.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A photovoltaic (PV) array emulator comprising:
a multi-stage power converter for providing a DC output; and,
a controller coupled to said multi-stage power converter, said controller configured to control operation of said multi-stage power converter as a function of an output current of said multi-stage power converter, an output voltage of said multi-stage power converter, and a PV array model.

2. A PV array emulator in accordance with claim 1, wherein said controller comprises:
a memory device; and
a processor coupled to said memory device, said processor programmed to control operation of said multi-stage power converter as a function of the output current of said multi-stage power converter, the output voltage of said two-level power converter, and the PV array model.

3. A PV array emulator in accordance with claim 2, wherein the PV array model is stored in said memory device.

4. A PV array emulator in accordance with claim 1, wherein said multi-stage power converter comprises a multi-level power converter

5. A PV array emulator in accordance with claim 1, wherein the PV array model is configured to determine an output current reference as a function of the output voltage of said multi-stage power converter and at least one characteristic of an emulated PV array.

6. A PV array emulator in accordance with claim 5, wherein the PV array model is configured to scale the output current reference as a function of a selectable temperature and a selectable irradiance level.

7. A PV array emulator in accordance with claim 5, wherein the PV array model is configured to calculate an output current of the solar cell being emulated at the output voltage of said multi-stage converter based, at least in part, on the at least one characteristic of the emulated PV array.

8. A PV array emulator in accordance with claim 7, wherein the PV array model is configured to calculate an output current reference to cause the output current of said multi-stage converter to substantially equal the calculated output current of the emulated PV array.

9. A PV array emulator in accordance with claim 5, wherein the controller is configured to generate an error signal as a function of the output current and the output current reference and to control operation of said multi-stage power converter in response to the error signal.

10. A PV array emulator in accordance with claim 1, wherein said multi-stage power converter is selectively configurable to output up to about 1 megawatt of power.

11. A photovoltaic (PV) array emulator comprising:
a PV inverter configured to provide an AC output from a DC input; and,
a controller coupled to said PV inverter, said controller configured to operate said PV inverter in an inverter mode to provide an AC output from a DC input and configured to operate said PV inverter in an emulator mode to provide a DC output from an AC input.

12. A PV array emulator in accordance with claim 11, wherein said controller is selectably configurable to operate said PV inverter in the inverter mode or the emulator mode.

13. A PV array emulator in accordance with claim 11, wherein said controller is configured to operate said PV inverter in the emulator mode to emulate a PV array.

14. A PV array emulator in accordance with claim 13, wherein said controller is configured to operate said PV inverter in the emulator mode as a function of an output voltage of said PV inverter, an output current of said PV inverter, and a PV array model.

15. A PV array emulator in accordance with claim 14, wherein the PV array model is configured to determine a desired output current of said PV inverter based, at least in part on at least one characteristic of an emulated PV array.

16. A method for use in testing a photovoltaic (PV) inverter, said method comprising:
coupling a first PV inverter to an AC power source;
coupling a second PV inverter to receive an output of the first PV inverter; and,
operating the first PV inverter to emulate a PV array and provide a DC power output to the second PV inverter.

17. A method in accordance with claim 16, wherein said operating the first PV inverter comprises operating the first PV converter as a function of an output current of the first PV inverter, an output voltage of the first PV inverter, and a PV array model.

18. A method in accordance with claim 17, wherein operating the first PV inverter to emulate a PV array comprises determining a desired output current for an emulated PV array at the output voltage of the first PV inverter and generating an output current reference to cause the first PV inverter to output the desired output current and the output voltage.

19. A method in accordance with claim 18, wherein operating the first PV inverter to emulate a PV array comprises scaling the desired output current as a function of a selected temperature and irradiance.

20. A method in accordance with claim 16, wherein coupling a second PV inverter to receive an output of the first PV inverter comprises coupling a second PV inverter substantially similar to the first PV inverter to receive an output of the first PV inverter.
